(19) United States
(12) Patent Application Publication
(10) Pub. No.: US 2026/0257255 A1
(43) Pub. Date: Sep. 3, 2026

(54) SELF-WEIGHT SWING CLAMP AND APPLICATIONS THEREOF

(71) Applicant: ASIA NEO TECH INDUSTRIAL CO., LTD., TAOYUAN CITY (TW)

(72) Inventors: PU-CHANG YEH, TAOYUAN CITY (TW); CHAO-MING CHENG, TAOYUAN CITY (TW)

(21) Appl. No.: 19/271,448

(22) Filed: Jul. 16, 2025

(30) Foreign Application Priority Data
Mar. 3, 2025 (TW) 114107739

(51) Int. Cl. B08B 13/00; B08B 3/02; B25B 5/04

(52) U.S. Cl. CPC B08B 13/00; B08B 3/02; B25B 5/04

(57) ABSTRACT

A self-weight swing clamp and applications thereof, comprising a seat portion and a clamp portion formed at one end of the seat portion. The clamp portion and the seat portion respectively generate a moment through their self-weights in the direction opposite the swinging direction. The moment generated by the clamp portion is greater than the moment generated by the seat portion, such that the seat portion is pressed by the object during placement, causing the seat portion and the clamp portion to swing together. The clamp portion can cover at least one of the functional slot holes on the object to protect the functional slot holes from contamination by the spraying substance.

### BACKGROUND OF INVENTION

### 1. Field of the Invention

The present invention relates generally to a clamp for covering the slot hole on an object, and more particularly to a self-weight swing clamp and applications thereof.

### 2. Description of Related Art

In industrial equipment, clamps are commonly installed on platforms, frames, or supports at the equipment end. These clamps are mainly used for positioning objects and do not have the function of covering special parts (such as slot holes) on the objects.

During industrial processes, painting or cleaning of objects are often required. Special parts of the objects such as slot holes must be covered to prevent painting substances (e.g., paint or cleaning solutions) from seeping into these areas. However, the prior art lack advanced clamping techniques to cover the special parts through the clamps. The objects must be covered before processing.

As we know, most existing clamps are designed with a slot (or mouth) capable of opening and closing according to the shape of the object to be clamped. A driving force is applied to control the time of opening and closing of the slot (or mouth). When the slot (or mouth) is open, the object can be placed. After placement of the object, the driven force controls the closing of the slot (or mouth) so as to clamp the object.

Additionally, the driving forces used by prior-art clamps generally include elastic forces generated by elastic components, or pushing forces, pulling forces, or rotational forces produced by electric, pneumatic, or electromagnetic actuators. However, the size, weight, and cost of these actuators configured will all increase the burden on the aforementioned clamp.

In addition, for the aforementioned objects that require spray dyeing, painting, or rinsing in industrial processes, the present invention takes the front-opening unified pod (FOUP) (a component used in current semiconductor manufacturing) as an example to explain the cleaning process required during the manufacturing process. This process is designed to remove harmful substances adhering to the FOUP, such as dust particles, Volatile Organic Compounds (VOCs), Sulfur Dioxide (SO2), Amines, Acids, Ammonia (NH3) etc. Specifically, the cleaning process includes a wet cleaning step where the door 12 and shell 11 of the FOUP are rinsed with a cleaning solution.

Furthermore, please refer to FIG. 1a, which shows that the structure of the conventional FOUP 10 is composed of a shell 11 and a door 12 connected via a locking mechanism. Before implementing the cleaning procedures, it is necessary to first unlock the door 12 (as shown in FIG. 1b), so that the door 12 can be separated from the shell 11. Then, the door 12 and shell 11 separated from each other are cleaned respectively.

Furthermore, as can be seen from FIG. 1b, the shell 11 is roughly in the shape of a hollow quadrilateral body and has an housing compartment 16 enclosed by the shell body and an opening 13 that is connected to the housing compartment 16 and open to the outside. The door 12 is roughly in the shape of a quadrilateral body and can cover the opening 13 of the shell 11 through a locking mechanism. Also, as can be seen from FIG. 1b and FIG. 1c, the door 12 has an outer surface 121 exposed outside the shell 11, an inner surface 122 located at the opposite end of the outer surface 121 and that can be hidden inside the shell, and an end wall 123 formed by extending the periphery of the inner surface 122, and the end wall 123 encloses the outer surface 121. Moreover, the door 12 has an inner compartment 125 for housing a locking mechanism (not shown in the figure), and the outer surface 121, the inner surface 122 and the end wall 123 enclose the periphery of the inner compartment 125. Specifically, FIG. 1b also discloses that the end wall 123 and the outer surface 121 respectively have a plurality of functional slot holes A connected to the inner compartment 125. The functional slot holes A include a plurality of ear holes A4 located on the end wall 123, and paired key holes A1, paired positioning holes A2 and a plurality of drain holes A3 located on the outer surface 121.

The ear hole A4 is provided to allow the latch ear 17 to flexibly retract into or extend out of the end wall 123, and the latch ear 17 forms an interlocking relationship with the locking mechanism inside the inner compartment 125. The paired key holes A1 are provided for inserting paired external keys to actuate the locking mechanism, thereby retracting the latch ear 17 on the ear hole A4 into the end wall 123 so as to open the door 12 on the shell 11. Conversely, the door 12 can also be latched and locked to the opening 13 of the shell 11 through the extension of the latch ear 17. Additionally, the paired positioning holes A2 are used to position the door 12 on the worktable surface of the process equipment, or to position the FOUP 10 with its shell 11 and door 12 already locked together. Furthermore, the plurality of drain holes A3 are connected to the inner compartment 125, and are used to drain accumulated water inside the inner compartment 125 (to be detailed later). Also, it is to be noted that some conventional doors 12 may additionally have other functional slot holes on the end wall 123, connected to the inner compartment 125.

Additionally, as disclosed in FIG. 1c, the inner surface 122 has an annular air-tight seal ring 14 to maintain the air-tight effect when the door 12 and the shell 11 are locked together. Furthermore, the inner surface 122 of the door 12 also has a plurality of slots 124 that correspond to the slots 111 inside the housing compartment 16 with aligned layers for positioning chips.

The aforementioned cleaning area station generally has at least one cleaning machine specifically responsible for carrying out the wet cleaning step in the cleaning process. Or, the cleaning machine can even perform steps including wet cleaning, water removal, and drying. All these cleaning machines are equipped with a cleaning chamber for holding the FOUP 10 to be cleaned, along with fluid pipelines that can supply cleaning solution and blowing gas, and heating element to supply thermal energy for drying.

Furthermore, before cleaning, the unlocked and separated door 12 and shell 11 can be transported into the cleaning machine via automated machinery such as a mechanical arm to undergo cleaning using the cleaning solution, gas, and heating elements.

In the present invention, the focus is on exploring the wet cleaning of the door 12 and shell 11 using a cleaning solution in the cleaning machine in the prior art, especially the wet cleaning of the door 12 with the functional slot holes A. In other words, according to the prior art, the door 12 and shell 11 can be placed in the cleaning chamber of the same cleaning machine to be simultaneously rinsed by the fluid, or the door 12 and shell 11 can be classified, and the cleaning chambers of multiple cleaning machines can be used to clean the door 12 and the shell 11 respectively.

Furthermore, manufacturers in the industry maintain stringent cleanliness requirements for the surrounding walls and surfaces of the housing compartment 16 to ensure process quality for workpieces (e.g., wafers). In other words, the cleanliness standards for the inner surface 122 of the door 12 (including slots 124) and its airtight seal ring 14, as well as the inner wall 110 of the shell 11 (including slot 111), are significantly higher than those for the outer surface 122 of the door 12 and the outer walls 112 of the shell 11. This prevents harmful substances from contaminating workpieces held inside the housing compartment 16.

Please refer to FIG. 2a, which discloses the existing first type of FOUP cleaning machine 21 that can place the aforementioned shell 11 with its opening 13 facing downward inside its cleaning chamber 210, and position the aforementioned door 12 vertically on one side of the shell 11 in a spaced manner, such that the inner surface 122 of the door 12 faces towards the shell 11 while the outer surface 121 faces away from the shell 11. In addition, multiple nozzles 211, 212, and 213 are arranged between the inner surface 122 of the door 12 and the outer wall 112 of the shell 11, around the outer wall 11 of the shell 11, and within the housing compartment 16 respectively, to synchronously supply cleaning solution for cleaning the door 12 and the shell 11.

However, although some of the multiple nozzles 211 are arranged between the inner surface 122 and the shell 11 to simultaneously flush the inner surface 122 with high cleanliness requirements, the airtight seal ring 14 on it, and the outer wall 112 of the shell 11 in the lateral direction, during the wet cleaning process, the cleaning solution will splash everywhere in the cleaning chamber 210, and the inner surface 122 and the airtight seal ring 14 with high cleanliness requirements on the door 12 are adjacent to the outer wall 112 of the shell 11, resulting in the inner surface 122 and the airtight seal ring 14 being easily contaminated by the cleaning solution splashing from the outer wall 112 of the shell 11 during the cleaning process. In addition, although the outer surface 121 with multiple functional slot holes A (as shown in FIG. 1b) faces outward and is not directly exposed to the cleaning solution, the cleaning solution splashing everywhere in the cleaning chamber 210 can still flow into the inner compartment 125 through the key holes A1, the drain holes A3, and the ear holes A4 on the outer surface 121 shown in FIG. 1b, or other through-holes on the end wall 123 and accumulate there. Moreover, since the door 12 is flushed in a vertical position, it is not conducive to the full discharge of the cleaning solution accumulated in the inner compartment 125 from the ear holes A4. Also, it is known that the more cleaning solution accumulates in the inner compartment 125, the longer the cleaning time required for air blow water removal and drying by the heating element after cleaning, resulting in lowered cleaning efficiency of the door 12 or too much man-hour for cleaning the door 12. Therefore, improvement is urgently needed.

Please refer to FIG. 2b, which discloses the existing second-type FOUP cleaning machine 22. Its difference from the cleaning machine shown in FIG. 2a lies in that, within the cleaning chamber 220, the aforementioned door 12 is horizontally placed above the shell 11, with the inner surface 122 of the door 12 facing downward and the outer surface 121 facing upward. Some of the multiple nozzles 221 and 222, namely the nozzles 221, spray the cleaning solution from bottom to top to rinse the inner surface 122 with a higher cleanliness requirement, and the airtight seal ring 14 on it.

However, since the inner surface 122 with a higher cleanliness requirement and the airtight seal ring 14 on the door 12 face downward and are adjacent to the outer wall 112 of the shell 11 for flushing, the inner surface 122 and the airtight seal ring 14 are still prone to cross-contamination by the cleaning solution splashing from the outer wall 112 of the shell 11 during the cleaning process. In addition, although the outer surface 121 with multiple functional slot holes A (as shown in FIG. 1b) faces upward and does not directly face the cleaning solution, the cleaning solution splashing everywhere in the cleaning chamber 210 will still flow into the inner compartment 125 through the key hole A1, the drain holes A3, and the ear hole A4 on the outer surface 121 or other through-holes on the end wall 123 and accumulate there. Moreover, since both the drain holes A3 and the key hole A1 face upward, it is even more unfavorable for draining the cleaning solution accumulated in the inner compartment 125. Furthermore, the more cleaning solution accumulates in the inner compartment 125, the longer the cleaning time required for air blow water removal and drying with heating elements after cleaning. Therefore, it also causes the problem of lowered cleaning efficiency of the door 12, or too much man-hour for cleaning the door 12. So, improvements are still needed.

### SUMMARY OF THE INVENTION

This invention takes the door 12 of the FOUP shown in FIG. 1a to FIG. 1c as an example of the aforementioned object to illustrate the problem of the prior art to be solved by this invention, i.e., during the process where the door 12 is flushed with cleaning solution (a type of spraying substance), the cleaning solution can easily enter through the said functional slot holes into the inner compartment of the door and accumulate there, resulting in more man-hour needed for the subsequent water removal and drying processes.

The aforementioned technical problem can also easily happen in other objects to be painted or flushed that have the feature of the said functional slot holes A like the aforementioned door 12. Therefore, the general scope of the said objects should not be limited to the door 12 of the said FOUP 10, and the equipment used to paint or flush the said objects should also not be limited to the said cleaning chamber 210.

To address this problem, the inventor developed a self-weight swing clamp that can be assembled within the equipment end. The clamp is pressed against by the object awaiting painting/flushing during placement, thereby driving the clamp to cover the functional slot holes A. This prevents or reduces paint or cleaning solution from contaminating said functional slot holes A or accumulating within the inner compartment 125 of the door 12 through the functional slot holes A.

In a preferred implementation, the self-weight swing clamp includes a seat portion and a clamp portion formed at one end of the seat portion. The seat portion is used to provide pressure contact for the object, and the clamp portion is used to cover and clamp the functional slot holes. An L-shaped placement opening for placing the object is formed between the clamp portion and the seat portion. The clamp portion and the seat portion respectively generate a moment through their self-weight in the direction opposite the swinging direction. When the gravity load of the object is released from the clamp, the moment generated by the clamp portion is greater than that generated by the seat portion. Moreover, when the gravity load of the object is added to the clamp, the moment generated by the clamp portion is less than that generated by the seat portion.

In a further implementation, the clamp has a pivoting portion for pivotally connecting to the equipment end, and the centers of gravity of the clamp portion and the seat portion respectively maintain a moment arm relationship with the pivoting portion. Furthermore, the center of gravity of the clamp portion can be relatively far from the pivoting portion, and the center of gravity of the seat portion can be relatively close to the pivoting portion.

In further implementation, before the object is placed in the said placement opening, the placement opening is open towards the direction of gravity, while after the object is placed in the placement opening, the placement opening deviates from the direction of gravity.

In further implementation, the equipment end is configured with a stopper post extending to the side of the clamp to limit the swinging angle of the clamp. Moreover, a stopping portion is formed on one side of the clamp, and the stopper post is positioned between the stopping portion and a side wall of the clamp portion to restrict the swinging angle of the clamp.

In a further implementation, the equipment end is pivotally connected with a plurality of clamps to form a horizontal surface area for pressure contact and placement of the object.

In further implementation, the clamp is applied to a cleaning chamber, where the equipment end is a support frame inside the cleaning chamber. The cleaning chamber is equipped with multiple nozzles capable of injecting a cleaning solution along the direction of gravitational force. The object has an outer surface, an inner surface located at the opposite end of the outer surface, and an end wall surrounding the outer surface and the inner surface. At least one of the functional slot holes is formed on the end wall. The object is placed in the placement opening of the clamp with its inner surface facing the direction in which the multiple nozzles inject the cleaning solution, so that the seat portion can provide pressure contact for the outer surface of the object, and the clamp portion can clamp the end wall to cover at least one of the functional slot holes.

In a further implementation, a blocking surface for covering at least one of the functional slot holes is formed on one side of the clamp portion, and a supporting surface for pressure contact by the outer surface of the object is formed on one side of the seat portion. The placement opening is formed between the blocking surface and the supporting surface. Additionally, at least one of the functional slot holes is an ear hole. The ear hole houses a clamping ear that can protrude beyond the end wall, and an housing cavity capable of receiving the clamping ear is formed on the blocking surface of the clamp portion. Moreover, at least one of the functional slot holes also includes those formed on the outer surface. The object also has an inner compartment surrounded by the outer surface, the inner surface, and the end wall, and the inner compartment is connected to the outside via at least one of the functional slot holes. Also, at least one of the functional slot holes is at least either a key hole or a drain hole.

In another implementation, the object can be a door, which is unlocked and separated from a shell of a front-opening FOUP. Further, the cleanliness requirement of the inner surface is relatively higher than that of the outer surface and the end wall, and the inner surface has an annular airtight seal ring for airtight combination with the shell. A plurality of the nozzles are relatively close to the inner surface and the airtight seal ring, and relatively far from the outer surface, the end wall, and the functional slot holes.

Based on the aforementioned content, the effects to be achieved by the present invention include:
1. The clamp is designed to enable self-weight swing for opening and closing the placement opening without the need to configure driving components to control the operation, thereby simplifying the clamp's structure.
2. Said clamp is designed to have the ability to block the cleaning solution or paint injected from the equipment end from contaminating the functional slot holes of the object, and can further prevent or minimize as much as possible the entry of spraying substances such as cleaning solution or paint into the inner compartment of the object (e.g., the inner compartment of the said door) through the said functional slot holes.
3. When the object is the door of the FOUP, the door can be positioned with its outer surface facing downward to be clamped and covered by the clamp, thus facilitating the drainage of cleaning solution that inadvertently flows into the door's inner compartment. This can solve the issue of prolonged time required for air-blow water removal and heating and drying processes after wet cleaning.

Furthermore, based on the aforementioned technical features, the present invention can also enable the inner surface and airtight seal ring (which have higher cleanliness requirements) on the object (such as the aforementioned door) to face upward to receive direct flushing of the cleaning solution from top to bottom, thereby being relatively away from the outer wall of the shell that is prone to causing splashing of cleaning solution. This can protect the inner surface and airtight seal ring of the door from cross-contamination by the cleaning solution.

Further benefits and advantages of the present invention will become apparent after a careful reading of the detailed description with appropriate reference to the accompanying drawings.

### BRIEF DESCRIPTION OF THE DRAWINGS

FIG. 1a is a perspective view of a prior-art FOUP.

FIG. 1b is an exploded perspective view of the FOUP depicted in FIG. 1.

FIG. 1c is a perspective view of the FOUP in FIG. 1b when the door is flipped.

FIG. 2a is a sectional view of the shell and the door when the first-type prior-art cleaning machine is used to clean the FOUP.

FIG. 2b is a sectional view of the shell and the door when the second-type prior-art cleaning machine is used to clean the FOUP.

FIG. 3 is a flow chart of the present invention, disclosing the processes of placing and cleaning the object.

FIG. 4a to FIG. 4c are sequential operational views of FIG. 3, depicting the applications of the clamp of the present invention for placing the object and covering the functional slot holes on the object during the cleaning.

FIG. 5a is a perspective view of a preferred embodiment of the clamp depicted in FIG. 4a.

FIG. 5b to FIG. 5d are sequential operation state views of the clamp in FIG. 5a.

### DETAILED DESCRIPTION OF THE INVENTION

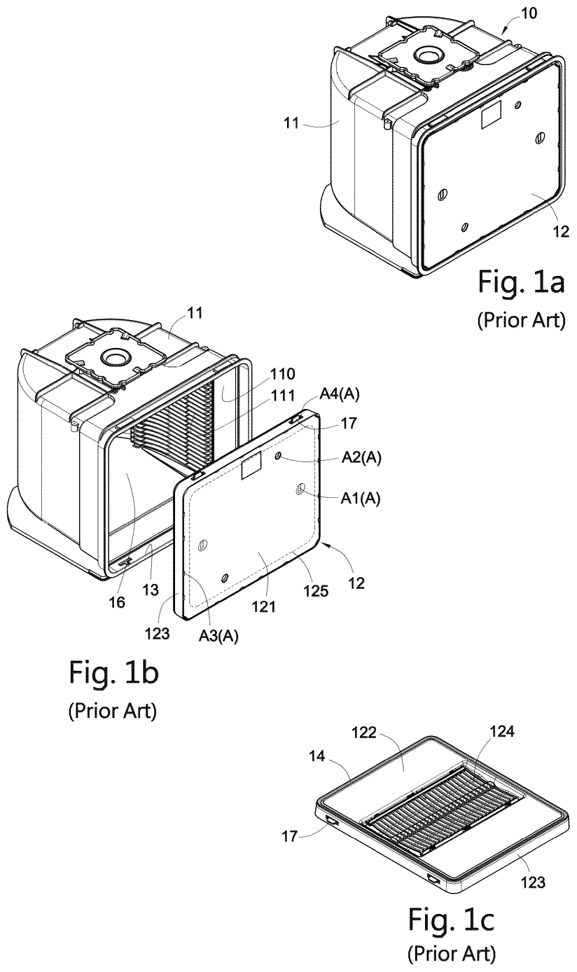

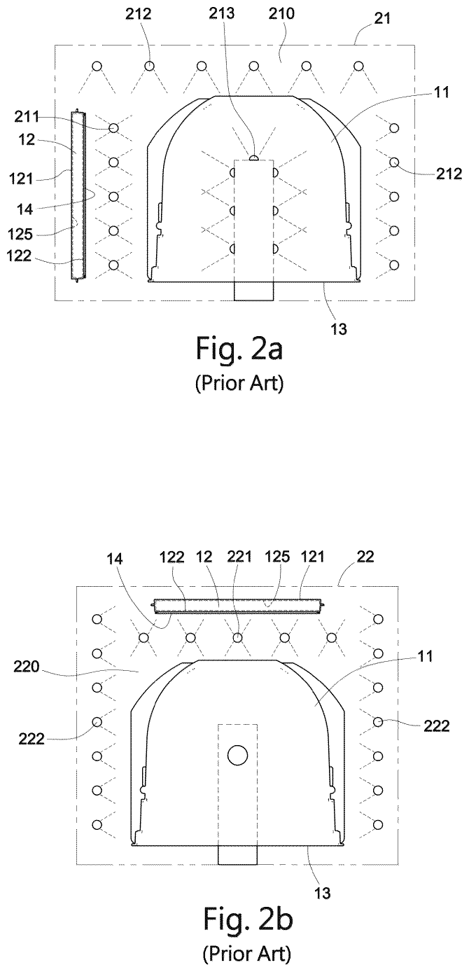

In the following descriptions of the present invention, the door 12 of the FOUP 10 depicted in FIG. 1a through FIG. 1c is used as an example of the object, and the cleaning chamber 31 for wet cleaning of the door 12 is used as an example of the equipment end, for describing the implementation details of the clamp 40.

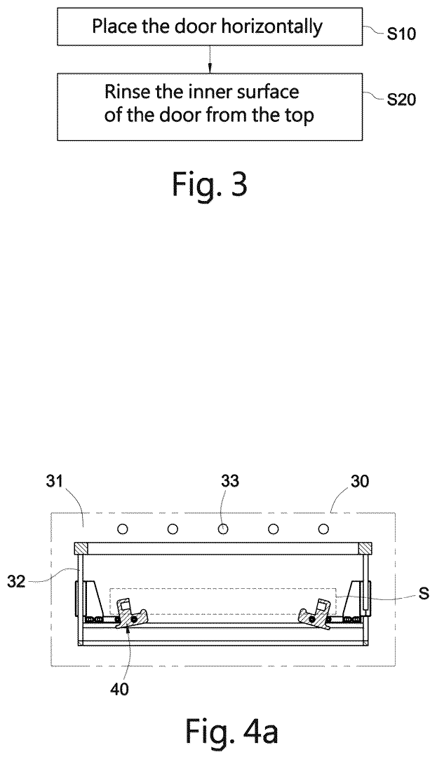

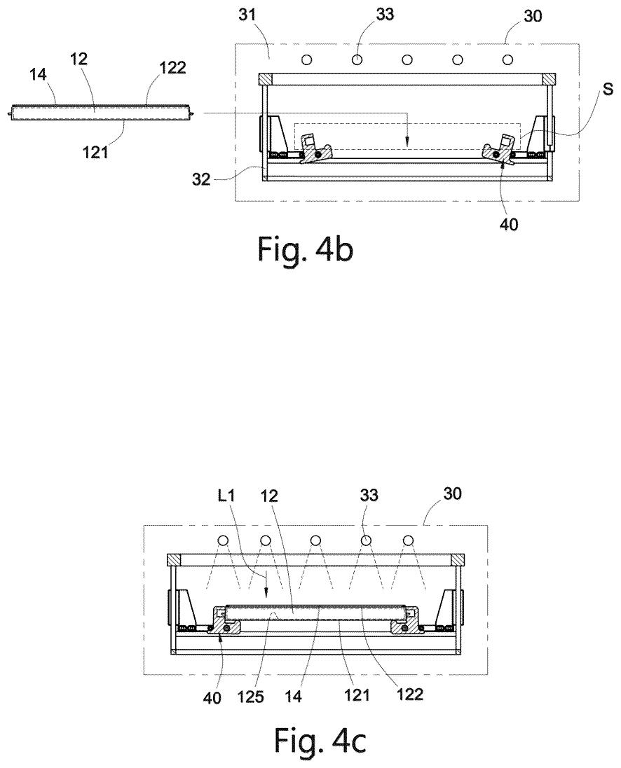

First, please refer to FIG. 3 in conjunction with FIGS. 4a to 4c, where FIG. 3 discloses a preferred implementation procedure for the wet cleaning of the door 12, and FIGS. 4a to 4c can help illustrate the implementation details for carrying out the wet cleaning procedure depicted in FIG. 3.

As shown in FIG. 4a, a cleaning machine 30 for individually performing wet cleaning for the door 12 is disclosed. This cleaning machine 30 can be formed by an enclosure with a cleaning chamber 31 that is connected to the atmosphere, housing a hollow support frame 32 to load the door 12. The support frame 32 provides a horizontal surface area S for placement of the door 12. In applicable implementations, the cleaning machine 30 includes a hatch that can open and close the cleaning chamber 31. The support frame 32 can move into/out of the hatch and cleaning chamber 31 via a lift mechanism, and may also have a door installed on it to seal the hatch when entering the cleaning chamber 31. Furthermore, a plurality of door nozzles 33 at intervals are fixedly installed in the upper section of the cleaning chamber 31 to supply cleaning solution. The support frame 32 can rotate within the cleaning chamber 31 via a drive mechanism, thereby rotating the door 12 inside to fully receive rinsing from the cleaning solution sprayed by the door nozzles 33. Additionally, the door nozzles 33 can also be mounted on the support frame 32, rotating along with the support frame 32 inside the cleaning chamber 31 while spraying cleaning solution to rinse the door 12.

FIG. 4b to FIG. 4c sequentially illustrate the implementation details of the procedure depicted in FIG. 3, from Step S10 to Step S20, including:
Step S10: Place the door horizontally.

As shown in FIG. 4b to FIG. 4c, in this step, the door 12 can be moved by automated machinery such as a robotic arm, which place the door 12 horizontally on the horizontal surface area S of the support frame 32 in such a way that the inner surface 122 with the airtight seal ring 14 on the door 12 faces upward and is exposed. Specifically, the door 12 can be placed on the horizontal surface area S of the support frame 32 when the support frame 32 extends out of the hatch of the cleaning machine 30 or when the hatch is opened to expose the horizontal surface area S of the support frame 32, thus be horizontally positioned on the support frame 32.

Further, the horizontal surface area S can be constructed by surrounding multiple pairs of clamps 40 arranged at intervals around the support frame 32. In other words, multiple pairs of clamps 40 are arranged at intervals on the support frame 32 according to the relative positions of the clamping ears 17 and their ear holes A on the end wall 123 of the door 12, or the relative positions of other through-holes communicating with the inner compartment 125 on the end wall 123, thereby forming the horizontal surface area S to allow the door 12 to be stably placed on multiple clamps 40 and maintained in a stable horizontal position with secure stopping. Herein, the term “horizontal” refers to the general range of a horizontal plane above the ground surface.

The said clamp 40 can be implemented as having a calibrated horizontal base surface, which not only provides a placement position for the door 12 but also can be configured as a groove structure at corresponding positions to clamp the end wall 123 and/or outer surface 121 of the door 12 so as to achieve horizontal placement. In addition, in another preferred embodiment, the said clamp 40 can also be implemented as a clamp type with a water-blocking function.

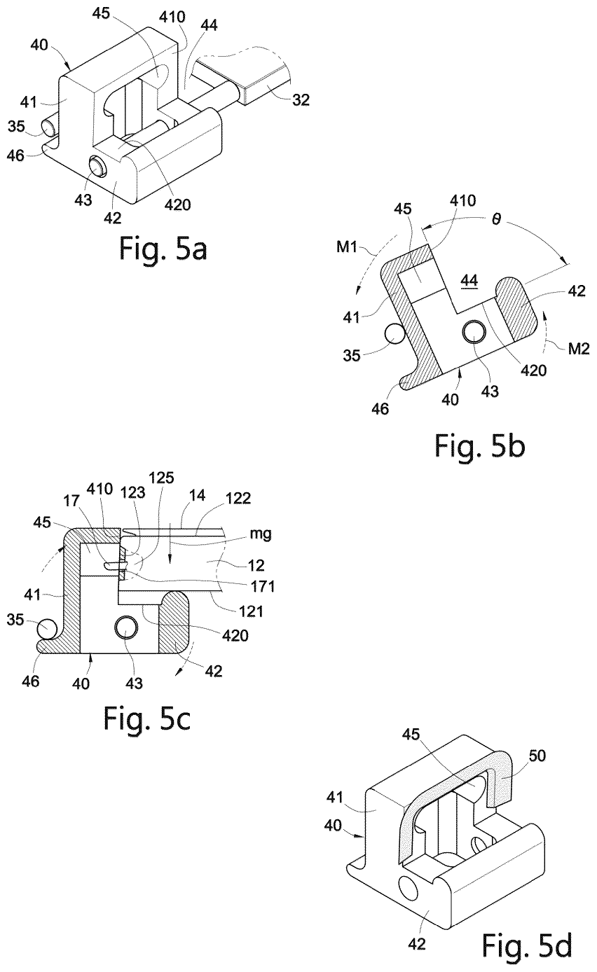

Please refer to FIG. 5a to FIG. 5c together, which disclose a preferred embodiment of the clamp 40 implemented with a water-blocking function, that is, using a swing clamp as the clamp 40. Specifically, FIG. 5a and FIG. 5b jointly disclose that the clamp 40 is integrally formed by a clamp portion 41 and a seat portion 42 at an included angle θ close to or equal to 90 degrees, making the clamp 40 present an L-shaped groove block. A blocking surface 410 is formed on one side of the clamp portion 41, and a supporting surface 420 is formed on one side of the seat portion 42. The included angle θ is formed between the blocking surface 410 and the supporting surface 420, so that an L-shaped placement opening 44 is formed between the blocking surface 410 and the supporting surface 420. Moreover, a housing cavity 45 can be formed on the blocking surface 410 of the clamp portion 41 to house the clamping ear 17 protruding from the end wall 123 of the door 12, and the surrounding area of the blocking surface 410 is larger than the ear hole A4 or other through-holes to be covered. In an alternative implementation, the blocking surface 410 can be formed into one of a gate-shaped body, a Π-shaped body, an inverted U-shaped body, or a straight-shaped body, so that the housing cavity 45 is surrounded inside or at the bottom edge of the blocking surface 410.

In addition, the clamp 40 can also form a pivoting portion 43 and stopping portion 46. The pivoting portion 43 can be presented in the form of a pivot hole or a pivot shaft, enabling the clamp 40 to be pivotally mounted on the support frame 32 via the pivoting portion 43. Further, the pivoting portion 43 can be arranged at the junction of the clamp portion 41 and the seat portion 42, or relatively close to the seat body 42, so that a moment arm is respectively formed between the center of gravity of the clamp portion 41 and the seat portion 42 and the pivoting portion 43. Moreover, under the action of gravity, the clamp portion 41 and the seat portion 42 can each generate a moment with the pivoting portion 43 as the center. In the present invention, it is deliberately planned that the moment M1 generated by the clamp portion 41 must be greater than the moment M2 generated by the seat portion 42, so that the clamp 40 can automatically swing upwards to open the placement opening 44 under the action of gravity without other external forces (as shown in FIG. 5b). Herein, by planning the volume and weight of the clamp portion 41 and the seat portion 42 and the length of the moment arm between their respective centers of gravity and the pivoting portion 43, the effect that the moment M1 of the clamp portion 41 is greater than the moment M2 of the seat portion 42 can be achieved.

In addition, the stopping portion 46 protrudes from one side of the clamp 40. The support frame 32 is provided with a stopper post 35 extending to the side of the clamp 40. The stopper post 35 is located between the stopping portion 46 and a side wall of the clamp portion 41 to limit the swinging angle of the clamp 40.

Specifically, once the moment M1 generated by the self-weight of the clamp portion 41 of the clamp 40 is greater than the moment M2 generated by the self-weight of the seat portion 42, through its self-weight, the clamp 40 swings to a state where the placement opening 44 is open upwards (as shown in FIG. 5b), and the stopper post 35 contacts the side wall of the clamp portion 41 to limit the swinging angle of the clamp 40. Here, the upwardly open placement opening 44 is used to allow the door 12 to first press against the seat portion 42 when being placed, and press the supporting surface 420 of the seat portion 42 by virtue of the self-gravity (mg) of the door 12, causing the clamp 40 to swing. The stopping portion 46 can receive the stop of the stopper post 35 to limit the swinging angle of the clamp 40, so as to maintain the placed door 12 in a horizontal position (as shown in FIG. 5c). When the door 12 is taken out of the cleaning chamber 31 by the automated machinery after cleaning, the clamp 40 is released from the gravity of the door 12, and releases the door 12 by automatically swinging back. As the moment M1 generated by the self-weight of the clamp portion 41 of the clamp 40 is greater than the moment M2 generated by the self-weight of the seat portion 42, the clamp 40 can automatically swing back to the original position shown in FIG. 5b.

Moreover, it is known that in the state shown in FIG. 5c, the door 12 is placed on the clamp 40. The clamp 40 can lean against the end wall 123 of the door 12 by virtue of the blocking surface 410 and embed the outer surface 121 of the door 12 by virtue of the supporting surface 420. Here, the blocking surface 410 can completely cover the ear hole A4 on the end wall 123 of the door 12 or other through-holes on the end wall 123 that are communicated with the inner compartment 125, and the housing cavity 45 can receive the clamping ear 17. Therefore, once the door 12 is placed horizontally (as shown in FIG. 4b) in the placement opening 44 of the clamp 40 (as shown in FIG. 4c and FIG. 5c) around the horizontal surface area S of the support frame 32, in addition to providing a horizontal placement for the door 12, the clamp 40 also has the function of preventing the cleaning solution from flowing into the inner compartment 125 through the ear hole A4 on the end wall 123 of the door 12 and accumulating therein, that is, enabling the clamp 40 to have the additional function of shielding the clamping ear 17 and its ear hole A4 from contacting the cleaning solution. In addition, please refer to FIG. 5d, which discloses another implementation form of the clamp 40, including disposing a soft pad 50 on the blocking surface 410 adjacent to the placement opening 44. The soft pad 50 can be fixed by means of adhesion or snap-fitting. The soft pad 50 can provide better anti-slip and water-shielding performance when the end wall 123 of the door 12 leans against it.

Step S20: Rinse the inner surface of the door from the top.

As shown in FIG. 4c, the plurality of door nozzles 33 arranged on the upper portion of the cleaning chamber 31 can spray cleaning solution downward following the direction of gravitational force, thereby defining a door rinsing path L1. The door rinsing path L1 represents the spraying trajectory of the multiple door nozzles 33 when spraying cleaning solution downward, and its direction may include vertical, diagonal, or a combination thereof. Since the inner surface 122 and airtight seal ring 14 of the placed door 12 having a high cleanliness requirement both face upward, they are relatively away from the outer wall 112 of the shell 11 that can easily cause splashing of the cleaning solution. This arrangement can effectively reduce contamination of the inner surface 122 and airtight seal ring 14 by the cleaning solution. Moreover, the inner surface 122 (and even the inner surface 122 together with the end wall 123) can receive thorough direct rinsing from the cleaning solution sprayed along the door rinsing path L1, effectively removing harmful substances adhering to the inner surface 122 and its airtight seal ring 14.

Since the outer surface 121 of the already placed door 12 is oriented downward, the multiple functional slot holes A (as shown in FIG. 1b) exposed on the outer surface 121 also open downward, thereby avoiding being rinsed by the cleaning solution sprayed from the door rinsing path L1. Accordingly, it is defined that the door rinsing path L1 excludes passage through the outer surface 121 and the functional slot holes A. Additionally, it is known that the inner compartment 125 of the door 12 can also be drained via the downward-opening functional slot holes A. Therefore, even if some cleaning solution from the cleaning chamber 31 accidentally flows into the inner compartment 125 through the functional slot holes A and the ear hole A4 due to spraying or splashing in other directions, the inner compartment 125 can smoothly drain the cleaning solution by leveraging its downward-opening characteristic. Furthermore, the clamp 40 has an additional function of shielding the clamping ear 17, preventing the ear hole A4 from contacting the cleaning solution. Through this design, the present invention effectively avoids the accumulation of cleaning solution inside the inner compartment 125 of the door 12, thus preventing subsequent problems of time-consuming air-blow water removal and heating and drying.

Moreover, the clamp 40 is not exclusively used to cover the clamping ear 17 and its ear hole A4 on the end wall 123 of the door 12. Any other decorative or functional slot holes on the end wall 123 of the door 12 that require shielding from sprayed materials can also be covered while using the clamp 40 to position the door 12.

In the above implementation, regarding the execution of the wet-cleaning procedure, in addition to placing the door 12 in the cleaning chamber 31, the shell 11 may also be placed to perform the wet-cleaning procedure synchronously. In addition, the terms regarding upper, lower, inner, and outer are defined based on the normal orientation of the objects shown in each diagram, wherein the top-to-bottom direction is the direction of gravitational force.

Furthermore, the aforementioned embodiments are used only for illustrating the preferred implementations of the present invention, and shall not be construed to limit the scope of the patent application. Specifically, the embodiments uses the door 12 as an example to describe the application and implementation details of the clamp 40 of the present invention. The object should not be restricted by this example. In other words, any application that employs the technical features of the clamp 40 to achieve reciprocating flipping and to cover the functional slot holes on the object through the clamp's self-weight and the addition/removal of object gravity before/after placement shall all fall within the application scope contemplated by the present invention. Ultimately, the present invention should be defined by the claims as specified in the patent application.

1. A self-weight swing clamp, pivotally connected to an equipment end to provide pressure contact by an object to cover at least one functional slot hole around the object, the clamp comprising:
a seat portion, to provide pressure contact by the object;
a clamp portion, formed at one end of the seat portion, used to cover and clamp the functional slot holes;
wherein:
an L-shaped placement opening is formed between the clamp portion and the seat portion for placing the object, through their self-weight, the clamp portion and the seat portion respectively generate a moment in a direction opposite the swinging direction;
when excluding the gravitational load of the object, the moment generated by the clamp portion is greater than that generated by the seat portion; and when including the gravitational load of the object, the moment generated by the clamp portion is smaller than that generated by the seat portion.

2. The self-weight swing clamp defined in claim 1, wherein the clamp comprises a pivoting portion configured for pivotal connection to the equipment end, and the center of gravity of the clamp portion and the center of gravity of the seat portion each maintain a moment arm relationship with the pivoting portion.

3. The self-weight swing clamp defined in claim 2, wherein the center of gravity of the clamp portion is relatively farther from the pivoting portion, and the center of gravity of the seat portion is relatively closer to the pivoting portion.

4. The self-weight swing clamp defined in claim 1, wherein prior to placement of the object in the placement opening, the placement opening is oriented toward the direction of gravitational force; after placement of the object in the placement opening, the placement opening deviates from the direction of gravitational force.

5. The self-weight swing clamp defined in claim 1, wherein the equipment end comprises a stopper post extending to the side of the clamp to restrict the swinging angle of the clamp.

6. The self-weight swing clamp defined in claim 5, wherein a stopping portion is formed on one side of the clamp, and the stopper post is positioned between the stopping portion and one sidewall of the clamp portion to restrict the swinging angle of the clamp.

7. The self-weight swing clamp defined in claim 1, wherein the equipment end is pivotally connected to a plurality of clamps to form a horizontal surface area for providing pressure contact and placement of the object.

8. The self-weight swing clamp defined in claim 1, applied to a cleaning chamber, wherein the equipment end is a support frame within the cleaning chamber, the cleaning chamber is provided with a plurality of nozzles capable of spraying cleaning solution along the direction of gravitational force, the object has an outer surface, an inner surface at the relative end of the outer surface, and an end wall enclosing the outer surface and inner surface, at least one of the functional slot holes is formed on the end wall, the object is placed into the placement opening of the clamp with its inner surface facing the direction of cleaning solution sprayed by the nozzles, so that the seat portion can provide pressure contact for the outer surface of the object, and the clamp portion can clamp the end wall to cover at least one functional slot hole.

9. The self-weight swing clamp defined in claim 8, wherein the clamp portion forms a blocking surface on one side to cover at least one of the functional slot holes, the seat portion forms a supporting surface on one side to provide pressure contact for the outer surface of the object, and the placement opening is formed between the blocking surface and the supporting surface.

10. The self-weight swing clamp defined in claim 9, wherein at least one of the functional slot holes is an ear hole, the ear hole houses a clamping ear protruding outward from the end wall, and the blocking surface of the clamp portion forms a housing cavity to receive the clamping ear.

11. The self-weight swing clamp defined in claim 8, wherein at least one of the functional slot holes is further formed on the outer surface, and the object further comprises an inner compartment enclosed by the outer surface, the inner surface, and the end wall, which is connected to the external environment via at least one functional slot hole.

12. The self-weight swing clamp defined in claim 11, wherein at least one of the functional slot holes is a key hole or drain hole.

13. The self-weight swing clamp defined in claim 12, wherein the object is a door, the door is separated from a shell of a front-opening unified pod (FOUP).

14. The self-weight swing clamp defined in claim 13, wherein the cleanliness requirement for the inner surface is relatively higher than the outer surface and the end wall, and the inner surface comprises an annular airtight seal ring for airtight combination with the shell. A plurality of nozzles are positioned relatively closer to the inner surface and the seal ring, and farther from the outer surface, the end wall, and the functional slot holes.
